(19) United States
(12) Patent Application Publication
(10) Pub. No.: US 2026/0175519 A1
(43) Pub. Date: Jun. 25, 2026

(54) ADDITIVE MANUFACTURING WITH DYNAMIC PRINTING RESOLUTIONS

(71) Applicant: Align Technology, Inc., San Jose, CA (US)

(72) Inventors: Yuxiang Wang, Newark, CA (US); Xirui Peng, Apex, NC (US); Viswanath Meenakshisundaram, Santa Clara, CA (US)

(21) Appl. No.: 19/427,804

(22) Filed: Dec. 19, 2025

Related U.S. Application Data
(60) Provisional application No. 63/737,294, filed on Dec. 20, 2024.

(51) Int. Cl. B29C 64/393; B22F 10/85; B33Y 50/02; B29L 31/00

(52) U.S. Cl. CPC B29C 64/393; B22F 10/85; B33Y 50/02; B29L 2031/753

(57) ABSTRACT

Methods and systems for designing and fabricating an additively manufactured object with dynamic printing resolutions are provided. In some embodiments, a method includes receiving a digital representation of a dental appliance, where the dental appliance includes a plurality of appliance portions. The method can also include determining a first printing resolution for a first appliance portion of the plurality of appliance portions. The method can also include determining a second printing resolution for a second appliance portion of the plurality of appliance portions, where the second printing resolution is lower than the first printing resolution. The method can further include generating instructions for fabricating the dental appliance via an additive manufacturing process.

### CROSS-REFERENCE TO RELATED APPLICATION(S)

The present application claims the benefit of priority to U.S. Provisional Application No. 63/737,294, filed December 20, 2024, the disclosure of which is incorporated by reference herein in its entirety.

### TECHNICAL FIELD

The present technology generally relates to additive manufacturing, and in particular, to methods and systems for designing and fabricating additively manufactured objects with dynamic printing resolutions.

### BACKGROUND

Additive manufacturing encompasses a variety of technologies that involve building up three-dimensional (3D) objects from multiple layers of material. Typically, the manufacturing process involves creating a digital model of an object, converting the model into a series of slices, and then sequentially printing the slices to build up the object in a layer-by-layer manner. 3D objects that are printed in this manner are conventionally printed using a single printing paradigm (e.g., a predefined printing speed, resolution), where each portion of a 3D object is printed with the same parameters. However, this can be inefficient, for instance, since not all portions of a 3D object require precise fabrication, such as portions that will be discarded after printing and/or portions that are not critical to the 3D object’s structure and/or function.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a flow diagram illustrating a general overview of a method for designing and fabricating a dental appliance, in accordance with embodiments of the present technology.

FIG. 2A illustrates a representative example of a dental appliance that can be designed and fabricated in accordance with embodiments of the present technology.

FIGS. 2B and 2C illustrate cross-sectional views of the dental appliance of FIG. 2A.

FIG. 3 illustrates a representative example of a dental auxiliary positioner that can be designed and fabricated in accordance with embodiments of the present technology.

FIG. 4A illustrates a representative example of a palatal expander that can be designed and fabricated in accordance with embodiments of the present technology.

FIG. 4B illustrates a dynamic sizing field for the palatal expander of FIG. 4A.

FIG. 5 illustrates a dental appliance including a plurality of support structures that can be designed and fabricated in accordance with embodiments of the present technology.

FIGS. 6A-6F illustrate representative examples of dynamic sizing fields, in accordance with embodiments of the present technology.

FIG. 7A illustrates a representative example of a tooth repositioning appliance configured in accordance with embodiments of the present technology.

FIG. 7B illustrates a tooth repositioning system including a plurality of appliances, in accordance with embodiments of the present technology.

FIG. 7C illustrates a method of orthodontic treatment using a plurality of appliances, in accordance with embodiments of the present technology.

FIG. 8 illustrates a method for designing an orthodontic appliance, in accordance with embodiments of the present technology.

FIG. 9 illustrates a method for digitally planning an orthodontic treatment and/or design or fabrication of an appliance, in accordance with embodiments of the present technology.

FIG. 10 is a partially schematic diagram providing a general overview of an additive manufacturing process, in accordance with embodiments of the present technology.

### DETAILED DESCRIPTION

The present technology relates to methods and systems for additive manufacturing with dynamic printing resolutions. An additive manufacturing process or system that produces a “dynamic printing resolution” can refer to any process or system in which the fabricated object has a heterogeneous printing resolution, e.g., different portions of the object are fabricated with different printing resolutions. The printing resolution can correlate to the minimum feature size (e.g., as measured in X-, Y-, and/or Z-dimensions) that the process or system can produce for the particular portion of the object, e.g., a “high” printing resolution correlates to a smaller minimum feature size, whereas a “low” printing resolution correlates to a larger minimum feature size.

In some embodiments, for example, a method includes receiving a digital representation of a dental appliance (e.g., an aligner, palatal expander, dental auxiliary positioner), where the dental appliance includes a plurality of appliance portions. The method can further include determining a first printing resolution for a first appliance portion of the plurality of appliance portions (e.g., a tooth-contacting surface of the appliance). The method can further include determining a second printing resolution for a second appliance portion of the plurality of appliance portions (e.g., a non-tooth-contacting surface of the appliance). The second printing resolution can be lower than the first printing resolution, such that the minimum feature size for the first appliance portion is smaller than the minimum feature size of the second appliance portion. The method can further include generating instructions for fabricating the dental appliance via an additive manufacturing process, where the instructions are configured to cause fabrication of the first appliance portion using first printing parameters configured to produce the first printing resolution, and to cause fabrication of the second appliance portion using second printing parameters configured to produce the second printing resolution. For instance, the first and second printing parameters may differ from each other with respect to energy dosage, energy intensity, energy wavelength, exposure time, spot or pixel size, layer thickness, grayscale value, and/or additive manufacturing technique.

The present technology can provide various advantages compared to conventional methods and systems for additive manufacturing. For instance, conventional approaches for designing and fabricating additively manufactured objects may involve single-setting (e.g., unimodal) printing, where every portion of an object is printed according to the same printing parameters. This can result in the entirety of the object being printed at a homogenous printing resolution, e.g., the highest resolution required for the smallest and/or most intricate object portions. As a result, larger and/or less intricate object portions may take more time to print and/or include greater detail than necessary. This relationship can be observed as a trade-off between printing throughput and printing accuracy. For instance, fabrication at a high printing resolution may produce higher printing accuracy, but may also take longer than fabrication at a low printing resolution; however fabrication at a lower printing resolution may result in lower printing accuracy. Moreover, time and resources allocated to printing object portions that are not part of the final object, such as sacrificial support structures, may not be as useful. Another advantage of the present technology is that the design processes for 3D objects can be customized on an object-by-object basis. For instance, the design and fabrication of dental appliances according to dynamic printing resolutions can account for individual variability in patient anatomy and/or treatment forces.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Additive Manufacturing with Dynamic Printing Resolutions

The present technology provides systems and methods for additive manufacturing of objects with dynamic printing resolutions. In some embodiments, an additively manufactured object is fabricated using a plurality of printing parameters configured to produce a corresponding plurality of printing resolutions. For instance, the additively manufactured object can be or include a dental appliance. The dental appliance may include a first appliance portion requiring higher accuracy and a second appliance portion requiring lower accuracy. Accordingly, the first appliance portion can be printed using printing parameters that produce the first appliance portion with a high printing resolution, and the second appliance portion can be printed using printing parameters that produce the second appliance portion with a low printing resolution. The high printing resolution may correspond to a minimum feature size (e.g., X-dimension, Y-dimension, and/or Z-dimension (such as layer height)) less than or equal to 200 microns, such as less than or equal to 175 microns, less than or equal to 150 microns, less than or equal to 125 microns, less than or equal to 100 microns, less than or equal to 75 microns, less than or equal to 50 microns, less than or equal to 25 microns, less than or equal to 15 microns, less than or equal to 10 microns, less than or equal to 5 microns, etc. The low printing resolution may correspond to a minimum feature size greater than or equal to 200 microns, such as greater than or equal to 225 microns, greater than or equal to 250 microns, greater than or equal to 275 microns, greater than or equal to 300 microns, greater than or equal to 400 microns, greater than or equal to 500 microns, etc. Generally, printing at a higher printing resolution takes more time and resources, e.g., due to greater repetitions (e.g., scanning passes) and/or the potential for artifacts and/or errors at smaller feature sizes. For example, if a high printing resolution corresponding to a minimum feature size of 50 microns is produced using a scanning laser spot size of 50 microns, and a low printing resolution corresponding to a minimum feature size of 300 microns is produced using a scanning laser spot of 300 microns, at least six scanning passes at the high printing resolution would be needed to print an equivalent surface area covered by one scanning pass at the low printing resolution. Thus, printing the different appliance portions at respective printing resolutions can increase the overall printing speed and improve resource allocation.

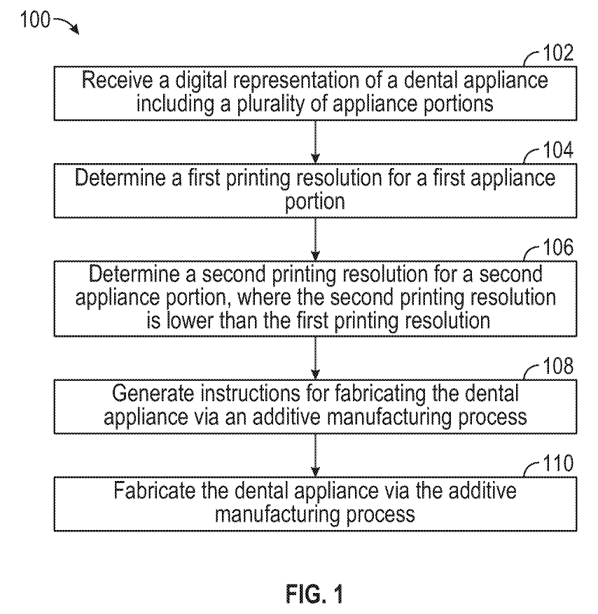

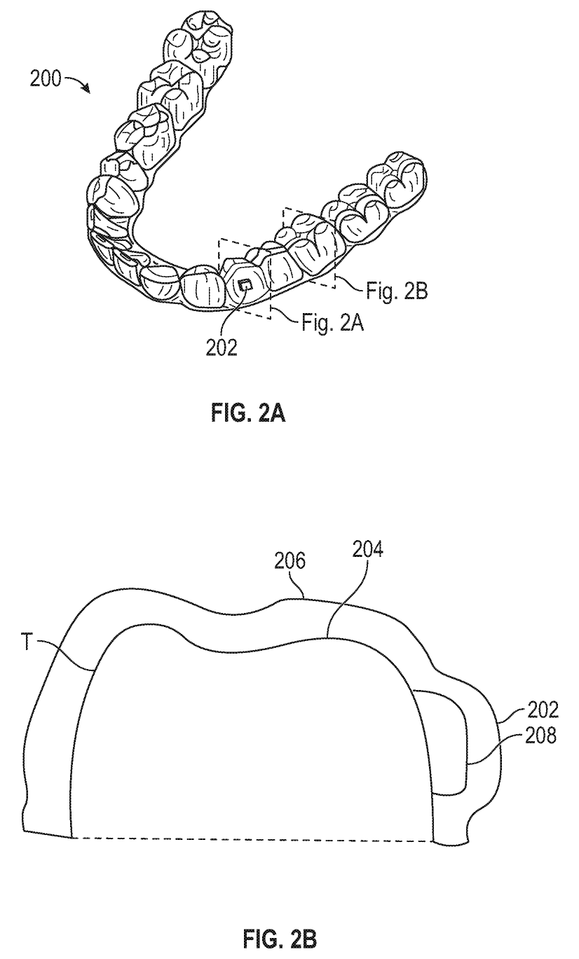

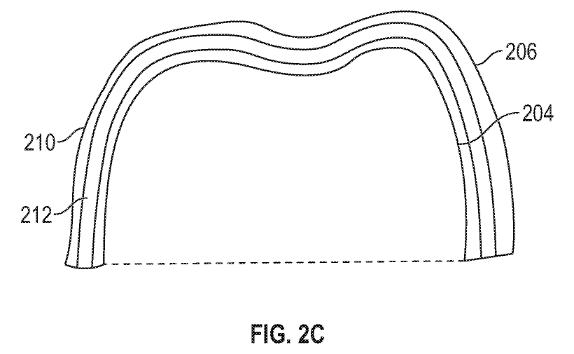

FIG. 1 is a flow diagram illustrating a general overview of a method 100 for designing and fabricating a dental appliance, in accordance with embodiments of the present technology. In some embodiments, the dental appliance is or includes an orthodontic appliance, such as an aligner, palatal expander, retainer, dental auxiliary positioner (e.g., an attachment placement device), and/or attachment. Alternatively or in combination, the dental appliance can be or include a restorative object, such as crowns, veneers, or implants. Further, the dental appliance may be or include other types of dental appliances such as an oral sleep apnea appliance and/or mouth guard. For instance, the method 100 can be used to design and fabricate any of the dental appliances described herein, such as the dental appliances described with respect to FIGS. 2A-5. Moreover, additional examples of dental appliances and associated methods that are applicable to the present technology are described in Section II below. In some embodiments, some or all of the processes of the method 100 are implemented as computer-readable instructions (e.g., program code) that are configured to be executed by one or more processors of a computing device (e.g., an appliance design system and/or an appliance fabrication system).

The method 100 can begin at block 102 with receiving a digital representation of a dental appliance including a plurality of appliance portions. The digital representation of the dental appliance can include one or more 3D digital models (e.g., surface model, mesh model, parametric model, non-parametric model, point cloud), 2D images, other digital data generated from the 3D digital models and/or 2D images (e.g., tensors), etc. The digital representation can be provided in any suitable file format, such as a CAD file, STL file, STP file, OBJ file, AMF file, 3MF file, BMP file, PNG file, VTK file, etc. In some embodiments, the digital representation of the dental appliance includes structured data (e.g., data presented in tables, arrays, lists, or other structured formats) that characterizes relevant features of the dental appliance. In some embodiments, the digital representation of the dental appliance includes a plurality of pixels or voxels. The pixels or voxels may be represented in bitmap space, where each pixel or voxel is represented by one or more values. Alternatively or in combination, the digital representation of the dental appliance may include one or more contours (e.g., contour lines) for characterizing relevant features of the dental appliance.

In some embodiments, the digital representation of the dental appliance can be generated using a computer system or device that implements software for designing appliances in accordance with a treatment plan. The appliance can be designed based on a treatment prescription received from a clinician and data of a patient’s teeth received from an intraoral state capture system. The intraoral state capture system can be configured to obtain sensor data of a patient’s dentition, intraoral cavity, and/or other relevant anatomical structures (e.g., craniofacial anatomy). The sensor data can depict the patient’s dentition in any suitable arrangement, such as an initial arrangement before the start of a treatment plan, an intermediate arrangement after treatment has commenced, or a final arrangement after the treatment has been completed. The sensor data can be generated via any suitable modality, and can include photographs, videos, scan data (e.g., intraoral and/or extraoral scans), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), and/or motion data. The sensor data can include 2D data (e.g., 2D photographs or videos), 3D data (e.g., 3D photographs, intraoral and/or extraoral scans, digital models), 4D data (e.g., fluoroscopy data, dynamic articulation data, hard and/or soft tissue motion capture data), or suitable combinations thereof.

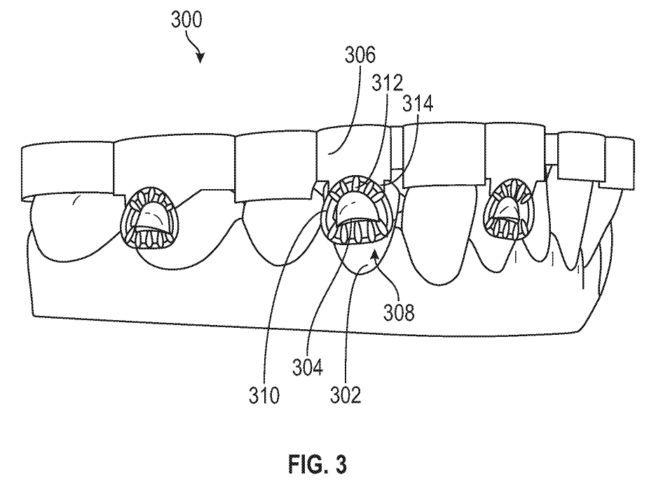

FIG. 2A illustrates a representative example of a dental appliance 200 that can be designed and fabricated in accordance with embodiments of the present technology. For example, in the illustrated embodiment, the dental appliance 200 is an aligner that is worn by a patient in order to achieve an incremental repositioning of individual teeth of a patient. Other types of dental appliances that are applicable to the present technology are described elsewhere herein, e.g., in connection with FIGS. 3-5 and Section II below.

The appliance 200 can include a shell (e.g., a continuous polymeric shell or a segmented shell) having teeth-receiving cavities that receive all teeth present in an upper or lower jaw, or less than all of the teeth. The appliance 200 can be designed specifically to accommodate the teeth of the patient and to reposition the teeth from a first tooth arrangement toward a second tooth arrangement in accordance with a dental treatment plan. In some cases, only certain teeth received by the appliance 200 are repositioned by the appliance 200 while other teeth can provide a base or anchor region for holding the appliance 200 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In some embodiments, the appliance 200 can be configured to accommodate one or more attachments positioned on the patient’s teeth. For instance, the appliance 200 can include an attachment-receiving well 202 shaped to receive an attachment. The appliance 200 can be configured to apply additional and/or alternative repositioning forces to the patient’s teeth via interactions between the attachment-receiving well 202 and the attachment.

Referring again to block 102 of FIG. 1, the dental appliance can include a plurality of appliance portions (e.g., parts, regions, surfaces, etc. of the appliance). The plurality of appliance portions can include any of the following: a portion adjacent or near one or more teeth, a portion spaced apart from one or more teeth, a portion adjacent or near the palate, a portion adjacent or near an attachment, an outer portion, an inner portion, a distal portion, a mesial portion, an occlusal portion, a gingival portion, an interproximal portion, a buccal portion, a lingual portion, and/or suitable combinations thereof. The dental appliance can include any suitable number of appliance portions, such as two, three, four, five, six, seven, eight, nine, 10, 20, 30, 40, 50, or more appliance portions.

The different appliance portions may have different properties and/or functions in the dental appliance. For example, some appliance portions may be configured to directly contact or be in close proximity to tissue of the patient (e.g., teeth, gingiva, palate, tongue, cheeks), while other appliance portions may be configured to be spaced apart from (e.g., not directly contact) tissue of the patient. As another example, some appliance portions may be configured to apply forces to the patient’s teeth (e.g., tooth reposition forces, palatal expansion forces, retention forces), while other appliance portions may be configured to apply substantially no forces to the patient’s teeth. In a further example, some appliance portions may be functional portions that are intended to be part of the final appliance, while other appliance portions may be sacrificial portions that are not intended to be part of the final appliance (e.g., support structures connecting the dental appliance to a build platform). In yet another example, some appliance portions may define the overall geometry of the dental appliance (e.g., the exterior surfaces of the appliance), while other appliance portions may serve primarily as structural support and/or filler (e.g., the interior volume of the appliance). Different appliance portions may have different accuracy requirements and/or manufacturing tolerances, e.g., based on their structure and/or function, and thus may benefit from different printing resolutions.

At block 104, the method 100 can continue with determining a first printing resolution for a first appliance portion of the plurality of appliance portions, and at block 106, the method 100 can continue at block 106 with determining a second printing resolution for a second appliance portion of the plurality of appliance portions, where the second printing resolution is lower than the first printing resolution. In some embodiments, the first appliance portion corresponds to a region of the dental appliance of higher structural and/or functional importance (e.g., the first appliance portion is important or required for the proper function and/or structural integrity of the dental appliance), while the second appliance portion corresponds to a region of the dental appliance of lower structural and/or functional importance (e.g., the second appliance portion is less important or not required for the proper function and/or structural integrity of the dental appliance).

For example, the first appliance portion can include a first appliance surface configured to contact or be in close proximity to a tissue (e.g., teeth, gingiva, palate, tongue, cheeks) of a patient and the second appliance portion can include a second appliance surface configured to be spaced apart from (e.g., not in contact with) the tissue of the patient. Alternatively or in combination, the first appliance portion can be configured to apply a repositioning force to a patient’s dentition and the second appliance portion may not be configured to apply repositioning forces to the patient’s dentition. Alternatively or in combination, the first appliance portion can include a functional portion of the dental appliance (e.g., a portion configured to engage an attachment on the patient’s teeth) and the second appliance portion can include a support structure for the dental appliance (e.g., a sacrificial structure that is not intended to be part of the final appliance). Alternatively or in combination, the first appliance portion may define the overall geometry of the dental appliance (e.g., the exterior surfaces of the appliance), while the second appliance portion may serve primarily as structural support and/or filler (e.g., the interior volume of the appliance).

In some embodiments, the first printing resolution can correspond to a minimum feature size less than or equal to 200 microns, such as less than or equal to 175 microns, less than or equal to 150 microns, less than or equal to 125 microns, less than or equal to 100 microns, less than or equal to 75 microns, less than or equal to 50 microns, less than or equal to 25 microns, less than or equal to 15 microns, less than or equal to 10 microns, less than or equal to 5 microns, etc. In some embodiments, the second printing resolution may correspond to a minimum feature size greater than or equal to 200 microns, such as greater than or equal to 225 microns, greater than or equal to 250 microns, greater than or equal to 275 microns, greater than or equal to 300 microns, greater than or equal to 400 microns, greater than or equal to 500 microns, etc. In some embodiments, the minimum feature size associated with the first printing resolution is at least 50 microns, 100 microns, 150 microns, 200 microns, 250 microns, 300 microns, 350 microns, or 400 microns less than the minimum feature size associated with the second printing resolution. Any of the minimum feature sizes described herein can refer to a feature size measured in the X-, Y-, and/or Z-dimensions. For instance, the minimum feature size can correspond to a minimum layer height, a minimum pixel width and length, a minimum laser spot size, etc.

The first and second printing resolutions can be determined based on the digital representation of the dental appliance. For instance, the digital representation of the dental appliance may include metadata (e.g., tags, labels, identifiers, boundary markers, contour lines) that identify appliance portions where high printing resolution or low printing resolution (and/or other printing resolutions) are required or preferable. Alternatively or in combination, the digital representation of the dental appliance can include metadata that identify different functional portions of the dental appliance (e.g., appliance portions that apply force or appliance portions that contact patient tissue). The metadata may be used to determine suitable printing resolutions for the appliance portions, e.g., certain functional portions may be associated with preferred or required printing resolutions.

In some embodiments, the first and second printing resolutions are determined using a software algorithm. For instance, the first and second printing resolutions may be automatically assigned to their respective appliance portions based on rule-based algorithms, machine learning algorithms, computer modeling systems, biomechanical systems or apparatus, and the like. Alternatively or in combination, the first and second printing resolutions can be determined based on user input. For instance, a dental practitioner, technician, or other user may determine suitable printing resolutions for the first appliance portion and the second appliance portion, with or without the assistance of software algorithms, computer modeling, and/or other automated systems. In some examples, the first and second printing resolutions are automatically assigned by a software algorithm, and the user can review and modify the first and second printing resolutions as desired. The printing resolutions described herein may be a preset value (e.g., a default printing resolution) and/or may be adjustable (e.g., based on user input), etc.

The dental appliance can be apportioned into first and second appliance portions and assigned printing resolutions in many different ways. Representative examples are discussed below in connection with FIGS. 2B-5.

FIGS. 2B and 2C illustrate cross-sectional views of the appliance 200 of FIG. 2A. Specifically, FIG. 2B is a first cross-sectional view of the appliance 200, and FIG. 2C is a second cross-sectional view of the appliance 200. Referring first to FIG. 2B, the appliance 200 can be configured to engage a patient’s tooth T when the appliance 200 is worn on the patient’s teeth. As depicted, the appliance 200 can include a tooth-contacting surface 204 and a non-tooth-contacting surface 206. In some embodiments, the tooth-contacting surface 204 is configured to engage the patient’s tooth T and, optionally, an attachment 208 positioned on the patient’s tooth T (e.g., via the attachment-receiving well 202). The geometry of the tooth-contacting surface 204 may be of high functional importance for repositioning the patient’s teeth according to the treatment plan. For example, the engagement between the tooth-contacting surface 204 and the tooth T and/or attachment 208 may control the location, direction, and/or magnitude of the forces applied to the tooth T. Further, the geometry of the tooth-contacting surface 204 may affect the fit and/or retention of the appliance 200 on the patient’s teeth. For instance, if the tooth-contacting surface 204 is fabricated with significant inaccuracies, the appliance 200 may fit poorly or not at all on the patient’s teeth. Accordingly, it may be desirable to fabricate the tooth-contacting surface 204 at a higher printing resolution. In contrast, the non-tooth-contacting surface 206 may have less functional relevance than the tooth-contacting surface 204 in repositioning the patient’s teeth, since there may not be substantial force transmitted to the teeth by the non-tooth-contacting surface 206. Further, the non-tooth-contacting surface 206 may not directly or substantially affect the fit and/or retention of the appliance 200 on the patient’s teeth. Accordingly, it may be desirable to fabricate the non-tooth-contacting surface 206 at a lower printing resolution to reduce manufacturing time and resources associated with fabricating the non-tooth-contacting surface 206.

Referring next to FIG. 2C, in some embodiments, the appliance 200 is alternatively or additionally fabricated to have a higher printing resolution at one or more exterior surfaces 210 of the appliance 200 versus an interior volume 212 of the appliance 200. The exterior surfaces 210 may include some or all of the outward-facing surfaces of the appliance 200, and may optionally include both the tooth-contacting surface 204 and the non-tooth-contacting surface 206. In some embodiments, the exterior surfaces 210 define an overall geometry (e.g., surface profile) of the appliance 200. Accordingly, it may be desirable to fabricate the exterior surfaces 210 with a high printing resolution to ensure a proper appliance geometry is produced. In contrast, the interior volume 212 can be less structurally and/or functionally relevant than the exterior surfaces 210. For instance, the interior volume 212 may be most relevant for general structural and/or mechanical integrity, and thus have a greater error tolerance than that of the exterior surfaces 210. Accordingly, the interior volume 212 may be fabricated at a lower printing resolution than the exterior surfaces 210. Other embodiments are possible. For instance, the appliance 200 can be fabricated to have a higher printing resolution in anterior portions of the appliance 200 than in posterior portions of the appliance 200, e.g., for aesthetic purposes. Alternatively or in combination, the appliance 200 can be fabricated to have a higher printing resolution in portions of the appliance 200 configured to apply a repositioning force to the patient’s dentition than in portions of the appliance 200 not configured to apply repositioning forces to the patient’s dentition. Further, the appliance 200 can be fabricated to have a higher printing resolution in portions that have small geometric features than in portions that have large geometric features.

FIG. 3 illustrates a representative example of a dental auxiliary positioner (“positioner 300”) that can be designed and fabricated in accordance with embodiments of the present technology. As shown, the positioner 300 can be placed on a patient’s teeth 302 having one or more auxiliaries 304 mounted thereon. An “auxiliary” or “dental auxiliary” can be any object that is affixed to one or more teeth and that is designed to engage a dental appliance (e.g., an aligner, attachment template, palatal expander, retainer, mouth guard) to facilitate an orthodontic treatment or to maintain/protect teeth, such as dental attachments, buttons, power arms, brackets, splints, distalizers, wires, etc. In the illustrated embodiment, for example, the auxiliaries 304 are attachments that engage respective portions of a dental appliance (not shown) to produce forces for repositioning the teeth 302. Auxiliaries may be placed on the lingual, buccal, and/or occlusal surfaces of one or more teeth. In some embodiments, the auxiliaries 304 may require high accuracy and can be fabricated with a higher printing resolution.

The positioner 300 can be used to place the auxiliaries 304 at predetermined locations on the teeth 302 so that the auxiliaries 304 engage properly with the dental appliance. In some embodiments, the positioner 300 includes one or more registration elements 306 configured to receive the teeth 302. A registration element 306 may receive a tooth by, for example, receiving and/or extending over only a portion of the tooth, such as the crown of the tooth, a portion of the tooth proximate to the crown, a buccal portion of an occlusal surface of the tooth, etc. A registration element 306 can be connected to another registration element 306 via rigid or flexible couplings to form a unitary appliance body. In some embodiments, the registration element 306 is configured to receive and engage a tooth to retain the positioner 300 in a specified spatial configuration with respect to the teeth 302. For instance, the registration element 306 can include a cavity formed therein to define a tooth-contacting surface that engages a corresponding surface of the received tooth (e.g., the occlusal, buccal, and/or lingual surface of the tooth).

Not all portions of the registration element 306 may require and/or benefit from a high printing resolution. In some embodiments, portions of the registration element 306 that are not configured to contact tissue of the patient (e.g., the non-tooth contacting surfaces of the registration element 306) can be fabricated with a lower printing resolution than portions of the registration element 306 that are configured to contact tissue of the patient (e.g., the tooth-contacting surface of the registration element 306). This can, for example, allow tooth-contacting surfaces of the registration element 306 to be fabricated with sufficiently high accuracy to conform to the patient’s teeth 302 without expending unnecessary time and resources on surfaces of the registration element 306 that are not configured to contact the teeth 302.

In some embodiments, the positioner 300 further includes one or more auxiliary supports 308 that are configured to position a corresponding auxiliary 304 at a predetermined location against or proximate to a surface of a tooth when the positioner 300 is placed on the patient’s teeth 302. In the illustrated embodiment, each auxiliary support 308 is coupled to a corresponding registration element 306 that receives the tooth to which the auxiliary 304 is to be mounted, such that when the registration element 306 engages the tooth, the auxiliary 304 is positioned at a predetermined location on the tooth. In some embodiments, precise placement of the auxiliary 304 on the patient’s teeth is desirable, and thus the auxiliary supports 308 can be fabricated with a higher printing resolution, such as a printing resolution greater than the printing resolution for the registration element 306.

The auxiliary support 308 can include a frame 310 that extends partially or entirely around a perimeter of the auxiliary 304, e.g., to protect/stabilize the auxiliary 304 during manufacturing, shipment, and/or handling. The frame 310 can be coupled directly to the registration element 306, or can be coupled indirectly via a bridge 314. The bridge 314 can be flexible to permit some movement of the frame 310 and auxiliary 304 relative to the corresponding registration element 306, or can be rigid so that the frame 310 and auxiliary 304 are maintained in a fixed spatial relationship with respect to the corresponding registration element 306. The frame 310 and/or the bridge 314 can be printed at a higher printing resolution, such as a printing resolution greater than the printing resolution for the registration element 306.

In some embodiments, the auxiliary 304 can be coupled to the frame 310 via a plurality of struts 312. Each strut 312 can be an elongate member including a first end connected to the frame 310 and a second end connected to the auxiliary 304. The struts 312 can be distributed around the perimeter of the auxiliary 304. In the illustrated embodiment, for example, the auxiliary support 308 includes a first set of struts 312 at a first (e.g., gingival) side of the auxiliary 304, and a second of struts 312 at a second (e.g., occlusal) side of the auxiliary 304. In some embodiments, the struts 312 are breakable components that are fractured to release the auxiliary 304 from the positioner 300 after the auxiliary 304 has been bonded to the tooth, thus allowing the positioner 300 to be removed while the bonded auxiliary 304 remains in place on the tooth. In some embodiments, the struts 312 are small features that require high accuracy to print, and thus the struts 312 can be fabricated at a higher printing resolution, such as a printing resolution higher than the printing resolutions corresponding to the registration element 306, frame 310, and/or bridge 314.

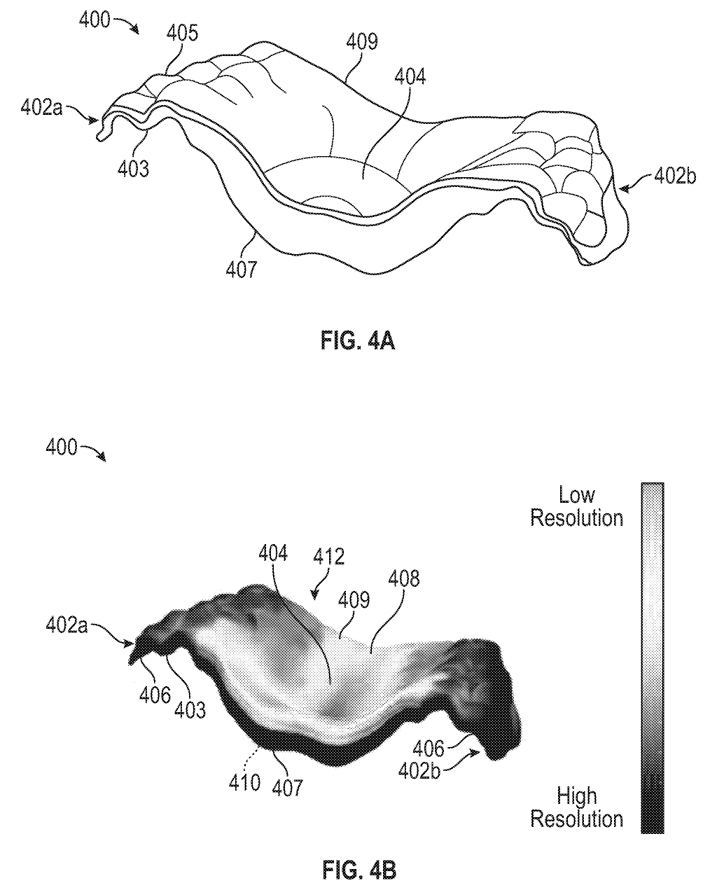

FIG. 4A illustrates a representative example of a palatal expander 400 that can be designed and fabricated in accordance with embodiments of the present technology. For instance, the palatal expander can be designed and fabricated using the method 100 of FIG. 1. In some embodiments, the palatal expander 400 is a polymeric dental appliance including a first tooth engagement portion 402a, a second tooth engagement portion 402b, and a palatal portion 404 between the first tooth engagement portion 402a and the second tooth engagement portion 402b. The first tooth engagement portion 402a can be configured to receive one or more first teeth at a first side of a patient’s dental arch, and the second tooth engagement portion 402b can be configured to receive one or more second teeth at a second, opposite side of the dental arch. The first teeth and the second teeth received by the first tooth engagement portion 402a and the second tooth engagement portion 402b, respectively, can include some or all of the posterior teeth, such as one or more molars and/or premolars. For example, the first teeth and the second teeth can be the three distalmost teeth on each side of the dental arch.

In the illustrated embodiment, the first tooth engagement portion 402a and the second tooth engagement portion 402b each include a set of cavities formed therein to receive the first teeth and the second teeth, respectively. An individual cavity may receive a tooth by, for example, receiving and/or extending over only a portion of the tooth, such as the crown of the tooth, a portion of the tooth proximate to the crown, a buccal surface of the tooth, a lingual surface of the tooth, etc. The cavity can include tooth-contacting surfaces 403 that conform to the occlusal, lingual, and/or buccal surfaces of the received tooth. Non-tooth-contacting surfaces 405 can be located on opposite surfaces of the tooth-contacting surfaces 403. In some embodiments, the tooth-contacting surfaces 403 are configured to transmit forces on the patient’s teeth to adjust the patient’s palate, whereas the non-tooth-contacting surfaces 405 are not configured to transmit forces on the patient’s teeth. Accordingly, it may be desirable to fabricate the tooth-contacting surfaces 403 with a high printing resolution and to fabricate the non-tooth-contacting surfaces 405 with a low printing resolution to improve manufacturing efficiency without compromising the effectiveness of palatal expansion via the palatal expander 400.

The palatal portion 404 can be positioned between the first tooth engagement portion 402a and the second tooth engagement portion 402b to couple these components to each other. When the palatal expander 400 is worn on the dental arch, the palatal portion 404 can be positioned proximate to the palate of the patient (e.g., spaced apart from some or all of the palatal surface, or in direct contact with some or all of the palatal surface). The palatal portion 404 can be configured to apply forces to the first tooth engagement portion 402a and the second tooth engagement portion 402b that are transmitted to the first teeth and the second teeth, respectively, to cause expansion of the patient’s palate. In some embodiments, the width of the palatal portion 404 is greater than the width of the dental arch when the palatal expander 400 is worn on the patient’s teeth, and the stiffness of the palatal portion 404 (e.g., which may vary according to the thickness and material properties of the palatal portion 404) is sufficiently high to generate and maintain a sufficient amount of force to cause expansion of the palate. The palatal portion 404 may include palate-contacting/adjacent surfaces 407 configured to be positioned in contact with or in close proximity to the patient’s palate, and non-palate-contacting surfaces 409 that are positioned away from the patient’s palate and are on the opposite surface of the palatal portion as the palate-contacting/adjacent surfaces 407. In some situations, the palate-contacting/adjacent surfaces 407 carry the risk of being abrasive and/or irritative to the patient’s palate, e.g., if inaccuracies in the geometry of the palate-contacting/adjacent surfaces 407 result in undesired and/or excessive contact with the palate tissue. Accordingly, it may be desirable to fabricate the palate-contacting/adjacent surfaces 407 with a high printing resolution and to fabricate the non-palate-contacting surfaces 409 with a low printing resolution to improve manufacturing efficiency without compromising patient comfort and/or injury prevention.

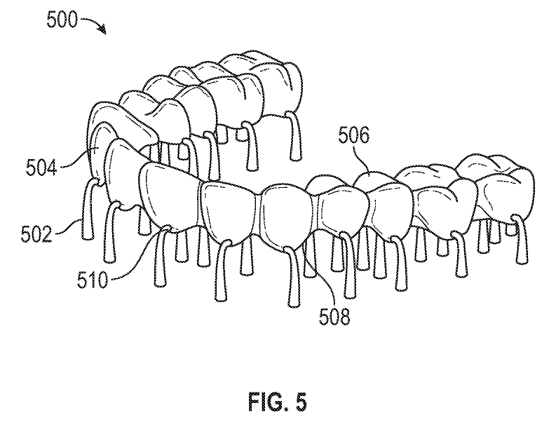

FIG. 5 illustrates a dental appliance 500 including a plurality of support structures 502 that can be designed and fabricated in accordance with embodiments of the present technology. The appliance 500 can be any of the dental appliances described herein, such as an aligner, palatal expander, attachment placement device, retainer, etc. In the illustrated embodiment, the appliance 500 includes a shell 504 having a plurality of cavities configured to receive some or all of a patient’s teeth. The shell 504 can be fabricated in a horizontal, “tooth tips up” configuration in which the occlusal surfaces 506 of the shell 504 are oriented upward and away from the build platform (not shown), and the gingival edges 508 of the shell 504 are oriented downward and toward the build platform. The support structures 502 can be coupled to the external surfaces of the shell 504 at or near the gingival edges 508, such as the external buccal surface, the external lingual surface, and/or the external bottom surfaces of the gingival edges 508. Optionally, some support structures 502 can be coupled to an internal surface of the shell 504, such as an internal occlusal surface, an internal buccal surface, and/or an internal lingual surface.

Although FIG. 5 illustrates an example configuration of a appliance 500 with support structures 502, in other embodiments, the appliance 500 and support structures 502 can be configured differently. For instance, the appliance 500 can instead be fabricated in a “tooth tips down” configuration in which the occlusal surfaces 506 of the shell 504 are oriented downward and toward the build platform, and the gingival edges 508 of the shell 504 are oriented upward and away the build platform. Moreover, although the appliance 500 is depicted in a horizontal configuration in which the mesial-distal axis of the appliance 500 is parallel or substantially parallel to the build platform, the appliance 500 can alternatively be fabricated in a tiled configuration in which the mesial-distal axis is angled relative to the build platform, or in a vertical configuration in which the mesial-distal axis is orthogonal or substantially orthogonal to the build platform.

In some embodiments, the shell 504 is fabricated using a first set of printing parameters configured to produce a first printing resolution, and the support structures 502 can be fabricated using a second set of printing parameters configured to produce a second printing resolution less than the first printing resolution. This may be advantageous, for instance, since the support structures 502 may be sacrificial elements that are removed from the appliance 500 after fabrication, and thus may not require high accuracy.

Alternatively or in combination, the support structures 502 themselves may be fabricated with dynamic printing resolutions. For instance, portions of the support structures 502 that are directly connected to the shell 504 may be printed at a higher printing resolution than portions of the support structures 502 that are not directly connected to the shell 504. In some embodiments, connection interfaces 510 between a support structure 502 and the shell 504 are designed to be thinner than the rest of the support structure 502, e.g., to facilitate trimming of the support structure 502 after fabrication. Accordingly, it may be desirable to print the connection interface 510 with a high printing resolution due to the smaller size and/or to prevent premature fracturing of the support structure 502 at the connection interface 510. Alternatively or in combination, some of the support structures 502 may be fabricated at a higher printing resolution than other support structures 502. For instance, every other support structure 502 may be fabricated at a higher printing resolution than adjacent support structures 502. Optionally, support structures 502 that are configured to support heavier and/or more critical portions of the appliance 500 may be fabricated with high printing resolutions. These approaches and more may advantageously reduce fabrication times and resources without sacrificing stability during fabrication.

Although the above discussion of FIGS. 2A-5 provides representative examples of different configurations of dynamic printing resolutions for dental appliances, this is not intended to be limiting, and any of the dynamic printing resolution configurations described herein can be modified as desired, e.g., based on patient anatomy, material properties, clinician preference, etc. Moreover, the techniques herein can be applied to other dental appliances or components thereof besides the embodiments shown in FIGS. 2A-5, such as attachments, precision cuts, buttons, hooks, precision wings, occlusal blocks, power ridges, bite adjustment structures, interproximal regions, cutouts, etc.

Returning to FIG. 1, the method 100 can optionally include determining one or more additional printing resolutions for one or more additional appliance portions besides the first and second appliance portions. For example, the method 100 can include determining a third printing resolution for a third appliance portion of the plurality of appliance portions, where the third appliance portion can be located between the first and second appliance portions. The third printing resolution can be configured to provide a transition between the first and second printing resolutions, e.g., the third printing resolution can be greater than the second printing resolution and less than the first printing resolution.

For instance, the third printing resolution may be based on an interpolation between the first printing resolution and the second printing resolution. The interpolation can produce a gradient of printing resolutions (also known as a “sizing field”) that provides a smooth transition between the first printing resolution and second printing resolution. Various types of interpolation can be used, such as linear interpolation, radial basis interpolation, polynomial interpolation, spline interpolation, etc. Alternatively or in combination, the third printing resolution may be determined using a boundary-value problem approach, e.g., by solving a set of partial differential equations (e.g., via finite element methods), where the first and second printing resolutions define boundary conditions for the set of partial differential equations.

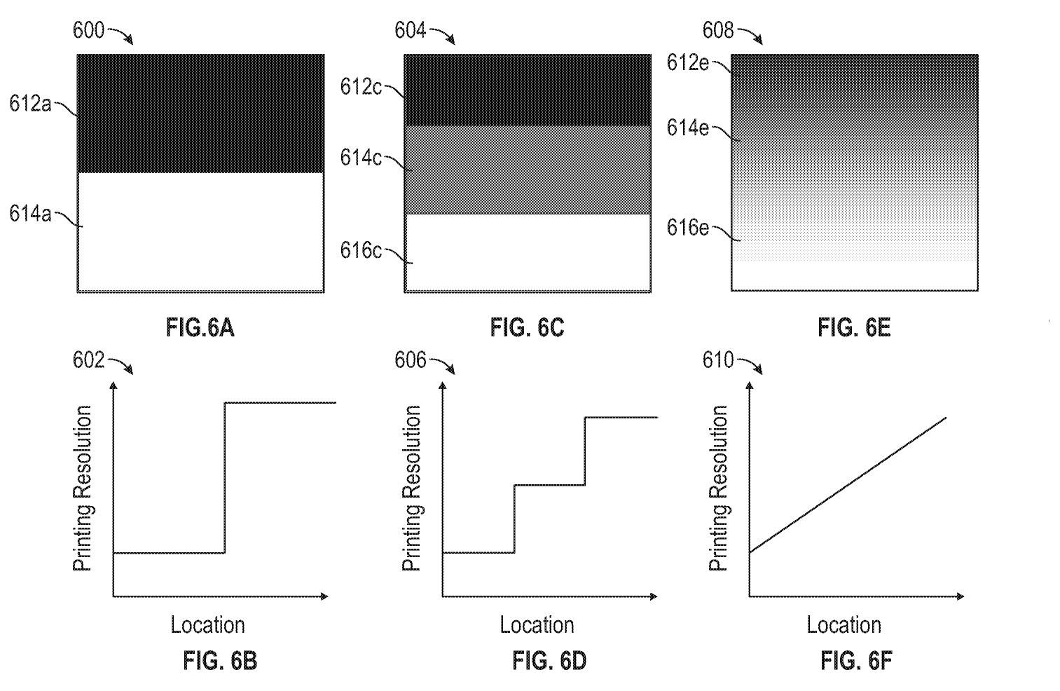

The determination of the third printing resolution can be determined in many different ways. Representative examples are discussed below in connection with FIGS. 4B and 6A-6F.

FIG. 4B illustrates a dynamic sizing field for the palatal expander 400 of FIG. 4A, in accordance with embodiments of the present technology. As shown in FIG. 4B, the palatal expander 400 includes a plurality of appliance portions with different printing resolutions as demarcated by grayscaling. In some embodiments, the appliance portions correspond to the anatomical portions described above with respect to FIG. 4A. Alternatively or in addition, the appliance portions can cover more than one anatomical portion, or less than one anatomical portion. As previously noted, it may be desirable to fabricate appliance portions that are configured to contact or be in close proximity to tissue (e.g., teeth, palate, gingiva) of the patient with a high printing resolution and to fabricate appliance portions that are spaced apart from tissue of the patient with a low printing resolution.

In some embodiments, the plurality of appliance portions includes a gradient of different printing resolutions. For instance, printing resolution can increase and/or decrease from a first appliance portion toward a second appliance portion, e.g., in a continuous manner, a step-wise manner, or suitable combinations thereof. This gradient can produce a smooth and/or continuous transition between low and high printing resolutions. In the illustrated embodiment, a first appliance portion 406 with a high printing resolution can include tissue contacting surfaces, such as the tooth-contacting surfaces 403 of the first tooth engagement portion 402a and the second tooth engagement portion 402b, as well as the palate-contacting/adjacent surfaces 407 of the palatal portion 404. A second appliance portion 408 with a low printing resolution can include non-tissue contacting surfaces, such as the non-palate-contacting surfaces 409 of the palatal portion 404. As indicated by the grayscaling in FIG. 4B, a plurality of printing resolutions can be interpolated between the first appliance portion 406 and the second appliance portion 408 to smooth the transition between the high printing resolution of the first appliance portion 406 and the lower printing resolution of the second appliance portion 408. Alternatively or in combination, printing resolutions can be interpolated between a high printing resolution for a third appliance portion 410 corresponding to an interior volume of the palatal expander 400 and a low printing resolution for a fourth appliance portion 412 corresponding to exterior surfaces of the palatal expander 400.

Although FIG. 4B depicts a dynamic sizing field for the palatal expander 400, it will be appreciated that dynamic sizing fields may be used for any of the other dental appliances described herein, e.g., in connection with FIGS. 2A-3 and 5.

FIGS. 6A-6F illustrate representative examples of dynamic sizing fields, in accordance with embodiments of the present technology. Specifically, FIG. 6A is a schematic illustration of a first dynamic sizing field 600, FIG. 6B is a first graph 602 corresponding to the first dynamic sizing field 600 of FIG. 6A, FIG. 6C is a schematic illustration of a second dynamic sizing field 604, FIG. 6D is a second graph 606 corresponding to the second dynamic sizing field 604 of FIG. 6C, FIG. 6E is a third dynamic sizing field 608, and FIG. 6F is a third graph 610 corresponding to the third dynamic sizing field 608 of FIG. 6E.

Referring first to FIG. 6A, the first dynamic sizing field 600 includes a high printing resolution portion 612a and a low printing resolution portion 614a. In contrast with the dynamic sizing fields described below, the dynamic sizing field 600 does not include an intermediate printing resolution portion between the high and low printing resolution portions 612a, 614a. As a result, there is a sharp transition between the high printing resolution portion 612a and the low printing resolution portion 614a, as represented by the step-function profile in the first graph 602 of FIG. 6B.

Referring next to FIG. 6C, the second dynamic sizing field 604 includes a high printing resolution portion 612c, a low printing resolution portion 616c, and an intermediate printing resolution portion 614c located between the high printing resolution portion 612c and the low printing resolution portion 616c. The printing resolution of the intermediate printing resolution portion 614c can be interpolated (e.g., averaged) between the printing resolutions of the high and low printing resolution portions 612c, 616c. As a result, there is a more gradual transition between the high printing resolution and low printing resolution, as represented by the three part step-function profile in the second graph 606 of FIG. 6D. Optionally, the intermediate printing resolution portion 614c can be subdivided into additional object portions, where the additional object portions correspond to additional incremental changes in printing resolution from the high printing resolution to the low printing resolution, thereby further smoothing the transition in a step-wise manner.

Referring next to FIG. 6E, the third dynamic sizing field 608 includes a high printing resolution portion 612e, a low printing resolution portion 616e, and an intermediate printing resolution portion 614e located between the high printing resolution portion 612e and the low printing resolution portion 616e. The intermediate printing resolution portion 614e can include a continuous gradient of printing resolutions that are linearly interpolated between the high printing resolution and the low printing resolution. As a result, there is a smooth and continuous transition between the high printing resolution and the low printing resolution, as represented by the linear profile in the third graph 610 of FIG. 6F. In other embodiments, other interpolation functions besides linear interpolation are possible, e.g., the printing resolution may be interpolated non-linearly, sinusoidally, exponentially, logarithmically, etc.

Referring again to FIG. 1, the method 100 can continue at block 108 with generating instructions for fabricating the dental appliance via an additive manufacturing process. In some embodiments, the instructions are or include a digital representation of the appliance design, such as a CAD file, STL file, OBJ file, AMF file, 3MF file, VTK file, etc. The digital representation can include a first component showing the surface geometry of the appliance design (e.g., a mesh), and a second component representing the printing resolutions to be used for the different application portions (e.g., a magnitude or other value for each location on the mesh). Alternatively or in combination, the instructions can include a toolpath file that is in a format suitable for direct input to the controller of an appliance fabrication systems, such as a G-code file.

The instructions can include different printing parameters for different appliance portions in order to produce the different printing resolutions. In some embodiments, the instructions are configured to cause fabrication of the first appliance portion using first printing parameters configured to produce the first printing resolution, and to cause fabrication of the second appliance portion using second printing parameters configured to produce the second printing resolution (and third appliance portion using third printing parameters as applicable).

The printing parameters may depend on the type of additive manufacturing technique and/or system used. In some embodiments, the additive manufacturing technique includes depositing a precursor material (e.g., a curable material such as a photopolymerizable resin, a sinterable material such as a polymeric powder) onto a build platform. The precursor material can be cured, polymerized, melted, sintered, fused, and/or otherwise solidified to form a portion of the object and/or to combine the portion with previously formed portions of the object. For example, an energy source (e.g., a laser, projector, or light engine) can be used to output energy to cause the curing, polymerizing, melting, sintering, fusing, etc., of the precursor material. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry. Representative examples of additive manufacturing techniques include digital light processing (DLP), stereolithography (SLA), selective laser sintering (SLS), fused deposition modeling, inkjet printing, or volumetric additive manufacturing, as well as the examples discussed in Section III below.

In some embodiments, the first printing parameters and the second printing parameters can differ from each other with respect to one or more of the following: energy dosage of the energy source of the additive manufacturing system, energy intensity of the energy source, energy wavelength of the energy source, exposure time of the energy source, spot or pixel size of the energy source, layer thickness for an individual additively manufactured layer, grayscale value, or additive manufacturing technique. For instance, the first printing parameters can include a lower energy dosage than the second printing parameters. The energy dosage delivered to a particular appliance portion may depend on the energy intensity and exposure time. Lower energy dosages may afford finer control over the resulting geometry and thus may be used for appliance portions with higher resolution. Additionally or alternatively, the first printing parameters can include a different energy wavelength than the second printing parameters. Different energy wavelengths may allow for smaller (e.g., finer) features and/or sharper edges to be fabricated and thus may be better suited for appliance portions requiring higher printing resolutions. Additionally or alternatively, the first printing parameters can include a smaller spot/pixel size than the second printing parameters. A smaller spot/pixel size can improve precision by creating smaller (e.g., finer) features in the X- and Y-dimensions in an appliance portion. Additionally or alternatively, the first printing parameters can include a smaller layer thickness than the second printing parameters. Similar to spot/pixel size, a smaller layer thickness can improve precision by creating smaller (e.g., finer) features in the Z-dimensions in an appliance portion.

As an example, in some embodiments, the first printing parameters include a different energy dosage than the second printing parameters. For light-based systems (e.g., scanning laser systems), energy dosage can be adjusted by increasing the current and/or varying the raster speed of the light source (e.g., a laser or LED) during an additive manufacturing process. In some embodiments, the first printing parameters may include applying energy at a first pulse width, and the second printing parameters may include applying energy at a second pulse width. The difference in pulse width may be controlled by a timing device, such as a clock source, which can drive the light source at a high intensity for a predetermined amount of time (e.g., in the range of 10–1000 ns). In some embodiments, the intensity of the light is directly proportional to the current and/or voltage supplied to the light source, whereas the energy dosage varies linearly as a function of the number of pulses per unit time (e.g., clock frequency).

Additionally or alternatively, the first printing parameters may include different grayscale values than the second printing parameters. For light-based systems, grayscaling may be used to control the energy dosage delivered by the light source. In such embodiments, the light source may be coupled to a dynamic mask device (e.g., a DLP projector), an LCD display, or other device that provides grayscaling capabilities. The energy dosage may be adjusted based on a dynamic mask determined by the dynamic mask device, which can improve control and/or discretization of energy delivery. For instance, a DLP system may use a digital micro-mirror device that includes a plurality of mirrors which can control the amount of light exiting the DLP system to achieve grayscaling. As another example, LCDs can alter the opacity at a pixel level, thereby allowing users to achieve grayscaling of input power and/or irradiance.

In embodiments where the additive manufacturing process is a powder bed fusion process (e.g., SLS), control over energy dosage and/or grayscaling may be achieved using a combination of pulse modulation of the energy source (e.g., an infrared light source such as a laser or LED) and a dynamic masking device (e.g., an infrared DLP projector). In such embodiments, background energy (e.g., powder cake heating) may be used to elevate the temperature of the powder material at or near the glass transition temperature of the material. The background energy may combine with the modulated and/or grayscaled energy in localized areas of the material, thus fusing the power particles at those areas into a solid structure. This approach is applicable to many different types of energy, such as ultraviolet energy, infrared energy, etc., or suitable combinations thereof.

As another example, in some embodiments, the first printing parameters include a high accuracy additive manufacturing technique and the second printing parameters include a low accuracy additive manufacturing technique. In some examples, a high accuracy additive manufacturing technique may include stereolithography (e.g., using a polygonal laser scanning system or other high accuracy laser system), and a low accuracy additive manufacturing technique may include digital light processing. In other examples, a high accuracy additive manufacturing technique may include stereolithography, and a low accuracy additive manufacturing technique may include inkjet printing or direct ink writing. In other examples, a high accuracy additive manufacturing technique may include digital light processing, and a low accuracy additive manufacturing technique may include inkjet printing or direct ink writing.

The method 100 can continue at block 110 with fabricating the dental appliance via the additive manufacturing process. The additive manufacturing process can involve fabricating the first appliance portion according to the first printing parameters and fabricating the second appliance portion according to the second printing parameters (and fabricating the third appliance portion according to the third printing parameters, if applicable).

The method 100 illustrated in FIG. 1 can be modified in many different ways. For example, the ordering of the processes shown in FIG. 1 can be varied, some of the processes of the method 100 can be omitted, and/or the method 100 can include additional processes not shown in FIG. 1. For instance, the process of block 106 can precede the process of block 104, or the processes of block 104 and 106 can occur substantially simultaneously. Moreover, the method 100 can include performing one or more post-processing operations on the dental appliance after fabrication, such as removing excess material (e.g., uncured resin) from the appliance, washing the appliance, post-curing the appliance, applying a coating or other surface treatment to the appliance, etc. In some embodiments, the excess material is removed using techniques to reduce the amount of material left within the interproximal portions of the appliance, such as centrifugation, heating, and/or solvents. Further, while the method 100 is described with respect to a single object (e.g., the dental appliance), the method 100 can be used to sequentially or concurrently design and fabricate any suitable number of objects, such as tens, hundreds, or thousands of additively manufactured objects.

While the method 100 of FIG. 1 has been described largely with respect to the design and fabrication of dental appliances, the present technology is not limited to dental appliances, and can be used for other types of medical devices or other additively manufactured objects. For instance, the present technology can be used to design and fabricate dental appliance molds for thermoforming, medical instruments, and/or manufacturing equipment.

### II.Dental Appliances and Associated Methods

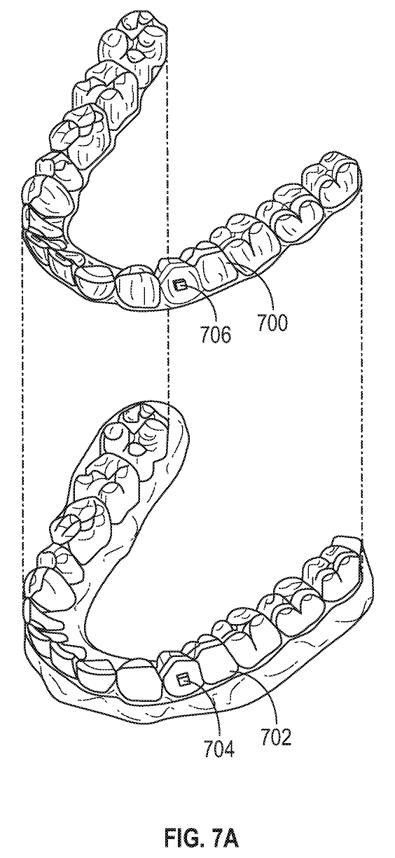

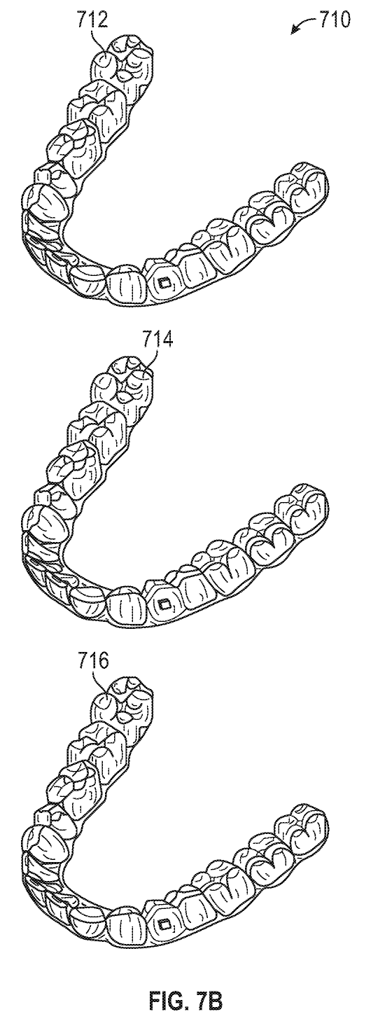

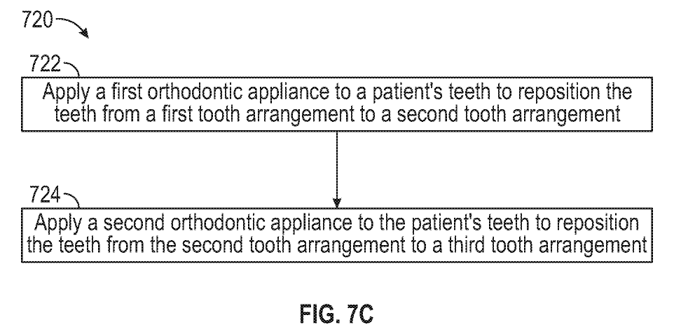

FIG. 7A illustrates a representative example of a tooth repositioning appliance 700 configured in accordance with embodiments of the present technology. The appliance 700 can be manufactured using any of the systems, methods, and devices described herein. The appliance 700 (also referred to herein as an “aligner”) can be worn by a patient in order to achieve an incremental repositioning of individual teeth 702 in the jaw. The appliance 700 can include a shell (e.g., a continuous polymeric shell or a segmented shell) having teeth-receiving cavities that receive and resiliently reposition the teeth. The appliance 700 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 700 can fit over all teeth present in an upper or lower jaw, or less than all of the teeth. The appliance 700 can be designed specifically to accommodate the teeth of the patient (e.g., the topography of the tooth-receiving cavities matches the topography of the patient’s teeth), and may be fabricated based on positive or negative models of the patient’s teeth generated by impression, scanning, and the like. Alternatively, the appliance 700 can be a generic appliance configured to receive the teeth, but not necessarily shaped to match the topography of the patient’s teeth. In some cases, only certain teeth received by the appliance 700 are repositioned by the appliance 700 while other teeth can provide a base or anchor region for holding the appliance 700 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 700 in place over the teeth. In some cases, however, it may be desirable or necessary to provide individual attachments 704 or other anchoring elements on teeth 702 with corresponding receptacles 706 or apertures in the appliance 700 so that the appliance 700 can apply a selected force on the tooth. Representative examples of appliances, including those utilized in the Invisalign® System, are described in numerous patents and patent applications assigned to Align Technology, Inc. including, for example, in U.S. Patent Nos. 6,450,807, and 5,975,893, as well as on the company’s website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Patent Nos. 6,309,215 and 6,830,450.

FIG. 7B illustrates a tooth repositioning system 710 including a plurality of appliances 712, 714, 716, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient’s teeth can be progressively repositioned from an initial tooth arrangement to a target tooth arrangement by placing a series of incremental position adjustment appliances over the patient’s teeth. For example, the tooth repositioning system 710 can include a first appliance 712 corresponding to an initial tooth arrangement, one or more intermediate appliances 714 corresponding to one or more intermediate arrangements, and a final appliance 716 corresponding to a target arrangement. A target tooth arrangement can be a planned final tooth arrangement selected for the patient’s teeth at the end of all planned orthodontic treatment. Alternatively, a target arrangement can be one of some intermediate arrangements for the patient’s teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient’s teeth that follows one or more incremental repositioning stages. Likewise, an initial tooth arrangement can be any initial arrangement for the patient’s teeth that is followed by one or more incremental repositioning stages.

FIG. 7C illustrates a method 720 of orthodontic treatment using a plurality of appliances, in accordance with embodiments of the present technology. The method 720 can be practiced using any of the appliances or appliance sets described herein. In block 722, a first orthodontic appliance is applied to a patient’s teeth in order to reposition the teeth from a first tooth arrangement to a second tooth arrangement. In block 724, a second orthodontic appliance is applied to the patient’s teeth in order to reposition the teeth from the second tooth arrangement to a third tooth arrangement. The method 720 can be repeated as necessary using any suitable number and combination of sequential appliances in order to incrementally reposition the patient’s teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

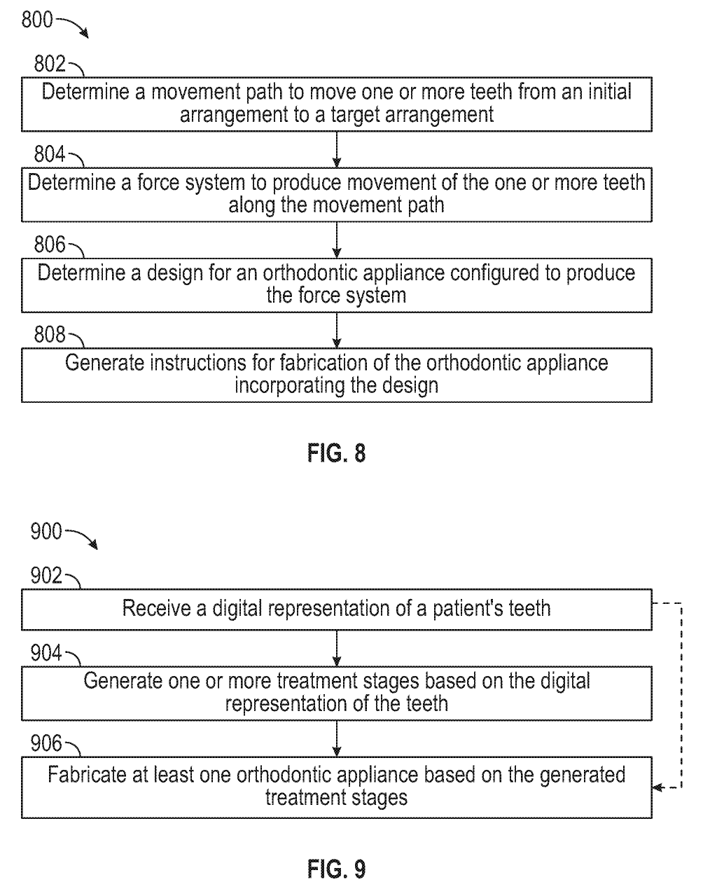

FIG. 8 illustrates a method 800 for designing an orthodontic appliance, in accordance with embodiments of the present technology. The method 800 can be applied to any embodiment of the orthodontic appliances described herein. Some or all of the steps of the method 800 can be performed by any suitable data processing system or device, e.g., one or more processors configured with suitable instructions.

In block 802, a movement path to move one or more teeth from an initial arrangement to a target arrangement is determined. The initial arrangement can be determined from a mold or a scan of the patient’s teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient’s teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth’s motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 804, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 804 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient’s mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient’s age—for example, young juvenile patients can require lower forces to expand the suture than older patients, as the suture has not yet fully formed.

In block 806, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 808, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 800 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 800 may be performed with any suitable fabrication system or device, such as the embodiments described herein. Some of the steps may be optional, e.g., the process of block 804 can be omitted, such that the orthodontic appliance is designed based on the desired tooth movements and/or determined tooth movement path, rather than based on a force system. Moreover, the order of the steps can be varied as desired.

FIG. 9 illustrates a method 900 for digitally planning an orthodontic treatment and/or design or fabrication of an appliance, in accordance with embodiments. The method 900 can be applied to any of the treatment procedures described herein and can be performed by any suitable data processing system.

In block 902, a digital representation of a patient’s teeth is received. The digital representation can include surface topography data for the patient’s intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 904, one or more treatment stages are generated based on the digital representation of the teeth. The treatment stages can be incremental repositioning stages of an orthodontic treatment procedure designed to move one or more of the patient’s teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 906, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 9, design and/or fabrication of an orthodontic appliance, and perhaps a particular orthodontic treatment, may include use of a representation of the patient’s teeth (e.g., including receiving a digital representation of the patient’s teeth (block 902)), followed by design and/or fabrication of an orthodontic appliance based on a representation of the patient’s teeth in the arrangement represented by the received representation.

As noted herein, the techniques described herein can be used for the direct fabrication of dental appliances, such as aligners and/or a series of aligners with tooth-receiving cavities configured to move a person’s teeth from an initial arrangement toward a target arrangement in accordance with a treatment plan. Aligners can include mandibular repositioning elements, such as those described in U.S. Patent No. 10,912,629, entitled “Dental Appliances with Repositioning Jaw Elements,” filed November 30, 2015; U.S. Patent No. 10,537,406, entitled “Dental Appliances with Repositioning Jaw Elements,” filed September 19, 2014; and U.S. Patent No. 9,844,424, entitled “Dental Appliances with Repositioning Jaw Elements,” filed February 21, 2014; all of which are incorporated by reference herein in their entirety.

The techniques used herein can also be used to manufacture attachment placement devices, e.g., appliances used to position prefabricated attachments on a person’s teeth in accordance with one or more aspects of a treatment plan. Examples of attachment placement devices (also known as “attachment placement templates” or “attachment fabrication templates”) can be found at least in: U.S. Application No. 17/249,218, entitled “Flexible 3D Printed Orthodontic Device,” filed February 24, 2021; U.S. Application No. 16/366,686, entitled “Dental Attachment Placement Structure,” filed March 27, 2019; U.S. Application No. 15/674,662, entitled “Devices and Systems for Creation of Attachments,” filed August 11, 2017; U.S. Patent No. 11,103,330, entitled “Dental Attachment Placement Structure,” filed June 14, 2017; U.S. Application No. 14/963,527, entitled “Dental Attachment Placement Structure,” filed December 9, 2015; U.S. Application No. 14/939,246, entitled “Dental Attachment Placement Structure,” filed November 12, 2015; U.S. Application No. 14/939,252, entitled “Dental Attachment Formation Structures,” filed November 12, 2015; and U.S. Patent No. 9,700,385, entitled “Attachment Structure,” filed August 22, 2014; all of which are incorporated by reference herein in their entirety.

The techniques described herein can be used to make incremental palatal expanders and/or a series of incremental palatal expanders used to expand a person’s palate from an initial position toward a target position in accordance with one or more aspects of a treatment plan. Examples of incremental palatal expanders can be found at least in: U.S. Application No. 16/380,801, entitled “Releasable Palatal Expanders,” filed April 10, 2019; U.S. Application No. 16/022,552, entitled “Devices, Systems, and Methods for Dental Arch Expansion,” filed June 28, 2018; U.S. Patent No. 11,045,283, entitled “Palatal Expander with Skeletal Anchorage Devices,” filed June 8, 2018; U.S. Application No. 15/831,159, entitled “Palatal Expanders and Methods of Expanding a Palate,” filed December 4, 2017; U.S. Patent No. 10,993,783, entitled “Methods and Apparatuses for Customizing a Rapid Palatal Expander,” filed December 4, 2017; and U.S. Patent No. 7,192,273, entitled “System and Method for Palatal Expansion,” filed August 7, 2003; all of which are incorporated by reference herein in their entirety.

### III. Overview of Additive Manufacturing Technology

The systems, methods, and devices described herein are suitable for use with a wide variety of additive manufacturing techniques. Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform, such as using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques.

For example, the additively manufactured object can be fabricated using a vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30 °C, 40 °C, 50 °C, 60 °C, 70 °C, 80 °C, 90 °C, 100 °C, 110 °C, or 120 °C. In some embodiments, the material is heated to a temperature within a range from 50 °C to 120 °C, from 90 °C to 120 °C, from 100 °C to 120 °C, from 105 °C to 115 °C, or from 105 °C to 110 °C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20 °C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Patent No. 7,892,474, the disclosure of which is incorporated herein by reference in its entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Patent No. 10,162,264 and U.S. Patent Publication No. 2014/0061974, the disclosures of which are incorporated herein by reference in their entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Patent No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry (e.g., inkjet printing).

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20 °C) or at an elevated temperature (e.g., a temperature within a range from 50 °C to 120 °C). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Patent No. 6,749,414 and U.S. Patent No. 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

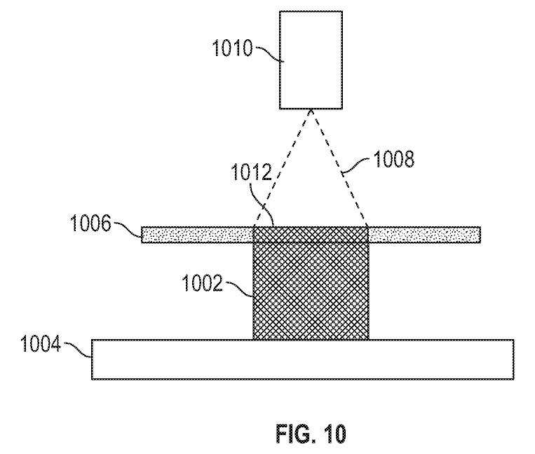

FIG. 10 is a partially schematic diagram providing a general overview of an additive manufacturing process, in accordance with embodiments of the present technology. Additive manufacturing (also referred to herein as “3D printing”) includes a variety of technologies which fabricate 3D objects directly from digital models through an additive process. For example, additive manufacturing can be used to directly fabricate orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

In the embodiment of FIG. 10, an object 1002 is fabricated on a build platform 1004 from a series of cured material layers, with each layer having a geometry corresponding to a respective cross-section of the object 1002. To fabricate an individual object layer, a layer of curable material 1006 (e.g., polymerizable resin) is brought into contact with the build platform 1004 (when fabricating the first layer of the object 1002) or with the previously formed portion of the object 1002 on the build platform 1004 (when fabricating subsequent layers of the object 1002). In some embodiments, the curable material 1006 is formed on and supported by a substrate (not shown), such as a film. Energy 1008 (e.g., light) from an energy source 1010 (e.g., a laser, projector, or light engine) is then applied to the curable material 1006 to form a cured material layer 1012 on the build platform 1004 or on the object 1002. The remaining curable material 1006 can then be moved away from the build platform 1004 (e.g., by lowering the build platform 1004, by moving the build platform 1004 laterally, by raising the curable material 1006, and/or by moving the curable material 1006 laterally), thus leaving the cured material layer 1012 in place on the build platform 1004 and/or object 1002. The fabrication process can then be repeated with a fresh layer of curable material 1006 to build up the next layer of the object 1002.

The illustrated embodiment shows a “top down” configuration in which the energy source 1010 is positioned above and directs the energy 1008 down toward the build platform 1004, such that the object 1002 is formed on the upper surface of the build platform 1004. Accordingly, the build platform 1004 can be incrementally lowered relative to the energy source 1010 as successive layers of the object 1002 are formed. In other embodiments, however, the additive manufacturing process of FIG. 10 can be performed using a “bottom up” configuration in which the energy source 1010 is positioned below and directs the energy 1008 up toward the build platform 1004, such that the object 1002 is formed on the lower surface of the build platform 1004. Accordingly, the build platform 1004 can be incrementally raised relative to the energy source 1010 as successive layers of the object 1002 are formed.

Although FIG. 10 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

### Examples

The following examples are included to further describe some aspects of the present technology, and should not be used to limit the scope of the technology.

Example 1. A method comprising:

receiving a digital representation of a dental appliance, wherein the dental appliance comprises a plurality of appliance portions;

determining a first printing resolution for a first appliance portion of the plurality of appliance portions;

determining a second printing resolution for a second appliance portion of the plurality of appliance portions, wherein the second printing resolution is lower than the first printing resolution; and

generating instructions for fabricating the dental appliance via an additive manufacturing process, wherein the instructions are configured to cause fabrication of the first appliance portion using first printing parameters configured to produce the first

printing resolution, and to cause fabrication of the second appliance portion using second printing parameters configured to produce the second printing resolution.

Example 2. The method of Example 1, wherein the first and second printing resolutions are determined based on the digital representation of the dental appliance.

Example 3. The method of Example 1 or 2, wherein the first and second printing resolutions are determined using a software algorithm.

Example 4. The method of any one of Examples 1 to 3, wherein the first and second printing resolutions are determined based on user input.

Example 5. The method of any one of Examples 1 to 4, wherein the first and second printing parameters differ from each other with respect to one or more of the following: energy dosage, energy intensity, energy wavelength, exposure time, spot or pixel size, layer thickness, grayscale value, or additive manufacturing technique.

Example 6. The method of any one of Examples 1 to 5, wherein the first printing parameters comprise a first printing speed and the second printing parameters comprise a second printing speed faster than the first printing speed.

Example 7. The method of any one of Examples 1 to 6, wherein the first printing parameters comprise a first spot or pixel size and the second printing parameters comprise a second spot or pixel size greater than the first spot or pixel size.

Example 8. The method of any one of Examples 1 to 7, wherein the first printing parameters comprise a first energy intensity and the second printing parameters comprise a second energy intensity greater than the first energy intensity.

Example 9. The method of any one of Examples 1 to 8, wherein the first printing parameters comprise a first layer thickness and the second printing parameters comprise a second layer thickness greater than the first layer thickness.

Example 10. The method of any one of Examples 1 to 9, wherein the first printing parameters comprise a high accuracy additive manufacturing technique and the second printing parameters comprise a low accuracy additive manufacturing technique.

Example 11. The method of any one of Examples 1 to 10, further comprising:

identifying a third appliance portion located between the first and second appliance portions, and

determining a third printing resolution for the third appliance portion, wherein the third printing resolution is greater than the second printing resolution and less than the first printing resolution.

Example 12. The method of Example 11, wherein the third printing resolution is determined by interpolating between the first printing resolution and the second printing resolution.

Example 13. The method of Example 12, wherein the interpolation comprises a linear interpolation.

Example 14. The method of Example 12 or 13, wherein the interpolation comprises a radial basis function interpolation.

Example 15. The method of any one of Examples 12 to 14, wherein the interpolation comprises solving a set of partial differential equations, wherein the first and second printing resolutions define boundary conditions for the set of partial differential equations.

Example 16. The method of any one of Examples 1 to 15, wherein the first appliance portion comprises a first appliance surface configured to contact or be in close proximity to a tissue of a patient and the second appliance portion comprises a second appliance surface configured to be spaced apart from the tissue of the patient.

Example 17. The method of Example 16, wherein the tissue comprises one or more of the patient’s teeth, palate, or gingiva.

Example 18. The method of any one of Examples 1 to 17, wherein the first appliance portion is configured to apply a repositioning force to a patient’s dentition and the second appliance portion is not configured to apply repositioning forces to the patient’s dentition.

Example 19. The method of any one of Examples 1 to 18, wherein the first appliance portion comprises a functional portion of the dental appliance and the second appliance portion comprises a support structure for the dental appliance.

Example 20. The method of any one of Examples 1to19, wherein the first appliance portion comprises an exterior surface of the dental appliance and the second appliance portion comprises an interior volume of the dental appliance.

Example 21. The method of any one of Examples 1to20, wherein the dental appliance is an aligner, palatal expander, or attachment placement appliance.

Example 22. The method of any one of Examples 1 to 21, wherein the first printing resolution corresponds to a minimum feature size less than or equal to 50 microns and the second printing resolution corresponds to a minimum feature size greater than or equal to 300 microns.

Example 23. The method of any one of Examples 1 to 22, further comprising fabricating the dental appliance via the additive manufacturing process.

Example 24. The method of any one of Examples 1 to 23, wherein the additive manufacturing process comprises applying energy to a curable material.

Example 25. The method of any one of Examples 1 to 24, wherein the additive manufacturing process comprises one or more of digital light processing, stereolithography, selective laser sintering, fused deposition modeling, inkjet printing, or volumetric additive manufacturing.

Example 26. A dental appliance fabricated according to the method of any one of Examples 1–25.

Example 27. A system comprising:

one or more processors; and

a memory operably coupled to the one or more processors and storing instructions that, when executed by the one or more processors, cause the system to perform operations comprising:

receiving a digital representation of a dental appliance, wherein the dental appliance comprises a plurality of appliance portions,

determining a first printing resolution for a first appliance portion of the plurality of appliance portions,

determining a second printing resolution for a second appliance portion of the plurality of appliance portions, wherein the second printing resolution is lower than the first printing resolution, and

generating instructions for fabricating the dental appliance via an additive manufacturing process, wherein the instructions are configured to cause fabrication of the first appliance portion using first printing parameters configured to produce the first printing resolution, and to cause fabrication of the second appliance portion using second printing parameters configured to produce the second printing resolution.

Example 28. The system of Example 27, wherein the first and second printing resolutions are determined based on the digital representation of the dental appliance.

Example 29. The system of Example 27 or 28, wherein the first and second printing resolutions are determined using a software algorithm.

Example 30. The system of any one of Examples 27to29, wherein the first and second printing resolutions are determined based on user input.

Example 31. The system of any one of Examples 27 to 30, wherein the first and second printing parameters differ from each other with respect to one or more of the following: energy dosage, energy intensity, energy wavelength, exposure time, spot or pixel size, layer thickness, grayscale value, or additive manufacturing technique.

Example 32. The system of any one of Examples 27 to 31, wherein the first printing parameters comprise a first printing speed and the second printing parameters comprise a second printing speed faster than the first printing speed.

Example 33. The system of any one of Examples 27 to 32, wherein the first printing parameters comprise a first spot or pixel size and the second printing parameters comprise a second spot or pixel size greater than the first spot or pixel size.

Example 34. The system of any one of Examples 27to33, wherein the first printing parameters comprise a first energy intensity and the second printing parameters comprise a second energy intensity greater than the first energy intensity.

Example 35. The system of any one of Examples 27 to 34, wherein the first printing parameters comprise a first layer thickness and the second printing parameters comprise a second layer thickness greater than the first layer thickness.

Example 36. The system of any one of Examples 27to35, wherein the first printing parameters comprise a high accuracy additive manufacturing technique and the second printing parameters comprise a low accuracy additive manufacturing technique.

Example 37. The system of any one of Examples 27 to 36, wherein the operations further comprise:

identifying a third appliance portion located between the first and second appliance portions, and

determining a third printing resolution for the third appliance portion, wherein the third printing resolution is greater than the second printing resolution and less than the first printing resolution.

Example 38. The system of Example 37, wherein the third printing resolution is determined by interpolating between the first printing resolution and the second printing resolution.

Example 39. The system of Example 38, wherein the interpolation comprises a linear interpolation.

Example 40. The system of Example 38 or 39, wherein the interpolation comprises a radial basis function interpolation.

Example 41. The system of any one of Examples 38 to 40, wherein the interpolation comprises solving a set of partial differential equations, wherein the first and second printing resolutions define boundary conditions for the set of partial differential equations.

Example 42. The system of any one of Examples 27 to 41, wherein the first appliance portion comprises a first appliance surface configured to contact or be in close proximity to a tissue of a patient and the second appliance portion comprises a second appliance surface configured to be spaced apart from the tissue of the patient.

Example 43. The system of Example 42, wherein the tissue comprises one or more of the patient’s teeth, palate, or gingiva.

Example 44. The system of any one of Examples 27 to 43, wherein the first appliance portion is configured to apply a repositioning force to the patient’s dentition and the second appliance portion is not configured to apply repositioning forces to the patient’s dentition.

Example 45. The system of any one of Examples 27 to 44, wherein the first appliance portion comprises a functional portion of the dental appliance and the second appliance portion comprises a support structure for the dental appliance.

Example 46. The system of any one of Examples 27 to 45, wherein the first appliance portion comprises an exterior surface of the dental appliance and the second appliance portion comprises an interior volume of the dental appliance.

Example 47. The system of any one of Examples 27 to 46, wherein the dental appliance is an aligner, palatal expander, or attachment placement appliance.

Example 48. The system of any one of Examples 27 to 47, wherein the first printing resolution corresponds to a minimum feature size less than or equal to 50 microns and the second printing resolution corresponds to a minimum feature size greater than or equal to 300 microns.

Example 49. The system of any one of Examples 27 to 48, further comprising an additive manufacturing system, wherein the operations further comprise fabricating the dental appliance via the additive manufacturing process using the additive manufacturing system.

Example 50. The system of Example 49, wherein the additive manufacturing system comprises an energy source configured to apply energy to a curable material.

Example 51. The system of any one of Examples 27 to 50, wherein the additive manufacturing process comprises one or more of digital light processing, stereolithography, selective laser sintering, fused deposition modeling, inkjet printing, or volumetric additive manufacturing.

Example 52. A dental appliance comprising:

a first additively manufactured appliance portion formed from a first plurality of cured material layers, wherein the first additively manufactured appliance portion is formed with a first printing resolution; and

a second additively manufactured appliance portion formed from a second plurality of cured material layers, wherein the second additively manufactured appliance portion is formed with a second printing resolution less than the first printing resolution.

Example 53. The dental appliance of Example 52, wherein the first additively manufactured appliance portion comprises a first appliance surface configured to contact or be in close proximity to a tissue of a patient and the second additively manufactured appliance portion comprises a second appliance surface configured to be spaced apart from the tissue of the patient.

Example 54. The dental appliance of Example 53, wherein the tissue comprises one or more of the patient’s teeth, palate, or gingiva.

Example 55. The dental appliance of any one of Examples 52 to 54, wherein the first additively manufactured appliance portion is configured to apply a repositioning force to a patient’s dentition and the second additively manufactured appliance portion is not configured to apply repositioning forces to the patient’s dentition.

Example 56. The dental appliance of any one of Examples 52 to 55, wherein the first additively manufactured appliance portion comprises an exterior surface of the dental appliance and the second additively manufactured appliance portion comprises an interior volume of the dental appliance.

Example 57. The dental appliance of any one of Examples 52 to 56, wherein the dental appliance is an aligner, palatal expander, or attachment placement appliance.

Example 58. The dental appliance of any one of Examples 52 to 57, wherein the first printing resolution corresponds to a minimum feature size less than or equal to 50 microns and the second printing resolution corresponds to a minimum feature size greater than or equal to 300 microns.

Example 59. The dental appliance of any one of Examples 52 to 58, wherein the first plurality of layers comprise a first layer thickness and the second plurality of layers comprise a second layer thickness different than the first layer thickness.

Example 60. The dental appliance of any one of Examples 52 to 59, further comprising a third additively manufactured appliance portion formed from a third plurality of cured material layers, wherein the third additively manufactured appliance portion is formed with a third printing resolution between the first and second printing resolutions.

### Conclusion

Although many of the embodiments are described above with respect to systems, devices, and methods for designing and fabricating dental appliances, the technology is applicable to other applications and/or other approaches, such as designing and fabricating other additively manufactured objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-10.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a digital representation of a dental appliance, wherein the dental appliance comprises a plurality of appliance portions;
determining a first printing resolution for a first appliance portion of the plurality of appliance portions;
determining a second printing resolution for a second appliance portion of the plurality of appliance portions, wherein the second printing resolution is lower than the first printing resolution; and
generating instructions for fabricating the dental appliance via an additive manufacturing process, wherein the instructions are configured to cause fabrication of the first appliance portion using first printing parameters configured to produce the first printing resolution, and to cause fabrication of the second appliance portion using second printing parameters configured to produce the second printing resolution.

2. The method of claim 1, wherein the first and second printing parameters differ from each other with respect to one or more of the following: energy dosage, energy intensity, energy wavelength, exposure time, spot or pixel size, layer thickness, grayscale value, or additive manufacturing technique.

3. The method of claim 1, wherein the first printing parameters comprise a first spot or pixel size and the second printing parameters comprise a second spot or pixel size greater than the first spot or pixel size.

4. The method of claim 1, wherein the first printing parameters comprise a first energy intensity and the second printing parameters comprise a second energy intensity greater than the first energy intensity.

5. The method of claim 1, wherein the first printing parameters comprise a high accuracy additive manufacturing technique and the second printing parameters comprise a low accuracy additive manufacturing technique.

6. The method of claim 1, wherein the first appliance portion comprises a first appliance surface configured to contact or be in close proximity to a tissue of a patient and the second appliance portion comprises a second appliance surface configured to be spaced apart from the tissue of the patient.

7. The method of claim 1, wherein the first appliance portion comprises a functional portion of the dental appliance and the second appliance portion comprises a support structure for the dental appliance.

8. The method of claim 1, wherein the first appliance portion comprises an exterior surface of the dental appliance and the second appliance portion comprises an interior volume of the dental appliance.

9. The method of claim 1, wherein the dental appliance is an aligner, palatal expander, or attachment placement appliance.

10. The method of claim 1, further comprising fabricating the dental appliance via the additive manufacturing process.

11. A system comprising:
one or more processors; and
a memory operably coupled to the one or more processors and storing instructions that, when executed by the one or more processors, cause the system to perform operations comprising:
receiving a digital representation of a dental appliance, wherein the dental appliance comprises a plurality of appliance portions,
determining a first printing resolution for a first appliance portion of the plurality of appliance portions,
determining a second printing resolution for a second appliance portion of the plurality of appliance portions, wherein the second printing resolution is lower than the first printing resolution, and
generating instructions for fabricating the dental appliance via an additive manufacturing process, wherein the instructions are configured to cause fabrication of the first appliance portion using first printing parameters configured to produce the first printing resolution, and to cause fabrication of the second appliance portion using second printing parameters configured to produce the second printing resolution.

12. The system of claim 11, wherein the first and second printing parameters differ from each other with respect to one or more of the following: energy dosage, energy intensity, energy wavelength, exposure time, spot or pixel size, layer thickness, grayscale value, or additive manufacturing technique.

13. The system of claim 11, wherein the first printing parameters comprise a first spot or pixel size and the second printing parameters comprise a second spot or pixel size greater than the first spot or pixel size.

14. The system of claim 11, wherein the first printing parameters comprise a first energy intensity and the second printing parameters comprise a second energy intensity greater than the first energy intensity.

15. The system of claim 11, wherein the first printing parameters comprise a high accuracy additive manufacturing technique and the second printing parameters comprise a low accuracy additive manufacturing technique.

16. The system of claim 11, wherein the first appliance portion comprises a first appliance surface configured to contact or be in close proximity to a tissue of a patient and the second appliance portion comprises a second appliance surface configured to be spaced apart from the tissue of the patient.

17. The system of claim 11, wherein the first appliance portion comprises a functional portion of the dental appliance and the second appliance portion comprises a support structure for the dental appliance.

18. The system of claim 11, wherein the first appliance portion comprises an exterior surface of the dental appliance and the second appliance portion comprises an interior volume of the dental appliance.

19. The system of claim 11, wherein the dental appliance is an aligner, palatal expander, or attachment placement appliance.

20. The system of claim 11, further comprising an additive manufacturing system, wherein the operations further comprise fabricating the dental appliance via the additive manufacturing process using the additive manufacturing system.
